(19) United States
(12) Patent Application Publication
(10) Pub. No.: US 2007/0062343 A1
(43) Pub. Date: Mar. 22, 2007

(54) Breaker bar for heavy duty applications

(76) Inventor: Gerald Kenneth Dodson JR., Fallston, MD (US)

Correspondence Address: ARMSTRONG, KRATZ, QUINTOS,;HANSON & BROOKS, LLP, Intellectual Property Law Offices, 502 Washingtion Avenue, Suite 220, Towson, MD, 21204, US

(21) Appl. No.: 11/524,709

(22) Filed: Sep. 21, 2006

Related U.S. Application Data
(60) Provisional application No. 60/719,650, filed on Sep. 23, 2005.
(60) Provisional application No. 60/719,654, filed on Sep. 22, 2005.

(51) Int. Cl. B25B 23/16; B25G 1/00; B25G 1/04

(52) U.S. Cl. 81/177.2; 81/177.7

(57) ABSTRACT

A breaker bar having a first handle and a second handle, the handles being connected by a quick connect/disconnect structure. The first handle has a forwardly projecting cleat to which an attached member having a tang to receive a wrench socket. The handles are fitted to be received in a conventional tool box. A method of use is disclosed.

### CROSS REFERENCE TO RELATED APPLICATIONS

This application is related to provisional patent application Ser. No. 60/719,650, filed Sep. 22, 2005, which is incorporated herein in its entirety.

### BACKGROUND OF THE INVENTION

1. Field of the Invention

The application is directed to a breaker bar for loosening fasteners and more particularly to a breaker bar having two connectable handles and a drive tang.

2. Description of Related Art

Breaker bars to loosen a tightly engaged fastener such as a nut or bolt, have been known for many years. However, commercially available breaker bars are heavy in weight, subject to breakdown and usually have a ratcheting fitting. Examples of these breaker bars are disclosed in:

| | U.S. |
|---|---|
| Inventor(s) | Pat. No. |
| Lee | 2,263,508 |
| Raber | 5,109,737 |
| Scott | 5,392,673 |
| Twomlow | 5,471,899 |
| Long | 5,957,008 |
| Chiang | 6,339,979 |
| Lee | 6,408,721 |
| Tobako | 6,761,094 |
| Cerda | 6,883,402 |

There is a need for a very rugged, dependable and relatively light weight device which can be used to apply sufficient leverage (torque) to loosen a “frozen” fastener. This is especially needed in an auto or truck repair shop, in heavy-duty maintenance or in construction.

### OBJECT OF THE INVENTION

A breaker bar comprises a first elongated handle having a forwardly-projecting cleat and a bifurcated member straddles the cleat and is pivotably connected thereto by a transverse pivot pin. This member has a drive tang for removably receiving a wrench socket thereon. A secondary elongated handle is optionally connected to the first elongated handle end-to-end thereof by a quick connect/disconnect structure therebetween.

Preferably, both first and second elongated handles are of substantially the same length, wherein the handles fit within a conventional mechanic's tool box or tool tray. Knurls are provided on respective portions of the handles.

In a preferred embodiment, the quick connect/disconnect structure comprises a bayonet lock.

In another aspect, the present invention provides a method of removing a “frozen” nut or bolt head by use of the breaker bar herein claimed.

In accordance with the teachings of the present invention, there is disclosed a breaker bar comprising a first elongated handle having a forwardly-projecting cleat. A bifurcated member straddles the cleat and is pivotably connected thereto by a transverse pivot pin. The member has a drive tang for removably receiving a wrench socket thereon. A secondary elongated handle is optionally connected to the first elongated handle end-to-end thereof by a quick connect/disconnect structure therebetween.

In further accordance with the teachings of the present invention, there is disclosed a breaker bar comprising first and second elongated handles connected end-to-end thereof by a bayonet lock therebetween, thereby providing a quick connect/disconnect feature. The handles are substantially the same length for convenient storage within a mechanic's conventional tool box or tool tray. Each of the handles has respective knurled portions. The first elongated handle has a forwardly-projecting cleat. A member is pivotably connected to the cleat by a transverse pivot pin. The member has a drive tang for detachably receiving a wrench socket thereon.

In still further accordance with the teachings of the present invention, there is disclosed a method for using a breaker bar for removal of a fastener. A first elongated handle and a second elongated handle are provided. Each handle has a length to be fitted into a conventional mechanic's tool box. Each handle has a first end. Means are provided on the first ends of the handles to removably and quickly connect the handles to each other end to end. The first handle further has an opposite second end. A tang is pivotally connected to said second end. A wrench socket of a desired size is placed on the tang on the first handle. The wrench socket is connected to the fasteners wherein the first and second handles extend perpendicularly from the fastener. Leverage is applied to the second handle to loosen the fastener. The wrench socket is disconnected from the loosened fastener. The first elongated handle is disconnected from the second elongated handle and the handles are placed in the mechanic's tool box.

### BRIEF DESCRIPTION OF THE DRAWINGS

FIG. 1 is a perspective view of the prior art where a length of pipe is fitted over a wrench to loosen a “frozen” fastener.

FIG. 2 is a perspective view of a damaged wrench resulting from the procedure shown in FIG. 1.

FIG. 3 is a perspective view of injury to the user from the procedure of FIGS. 1 and 2.

FIG. 4 is a perspective view showing the broken wrench of FIG. 2.

FIG. 5 is a perspective view of the mechanic getting a standard breaker bar.

FIG. 6 is a perspective view showing the handles of the present invention fitted in a mechanic's tool chest.

FIG. 7 is a top plan view showing the present invention in the mechanic's tool chest.

FIG. 8 is a perspective view showing the handles removed from the tool box and being connected to form the breaker bar.

FIG. 9 is a perspective view showing the breaker bar of the present invention being used to open a fastener.

FIG. 10 is a perspective view showing the fastener removed

FIG. 11 is a perspective view of the present invention.

FIG. 12 is a side elevation view of the two handles shown adjacent to one another.

FIG. 13 is a partial cut-away view of one end of the first handle showing a pin mounted in the handle.

FIG. 14 is a perspective view of the end of the second handle showing a slot with an offset.

FIG. 15 is a partial cut-away view showing the engagement of the pin of FIG. 13 with the slots of FIG. 14.

FIG. 16 is a top plan view showing the cleat with the member pivotally connected thereto.

FIG. 17 is a side elevation view showing the member pivotally connected to the cleat.

FIG. 18 is a cross-sectional view taken across the lines 18-18 of FIG. 17.

FIG. 19 is a top elevation view showing an alternate embodiment wherein the cleat is bifurcated.

### DESCRIPTION OF THE PREFERRED EMBODIMENT

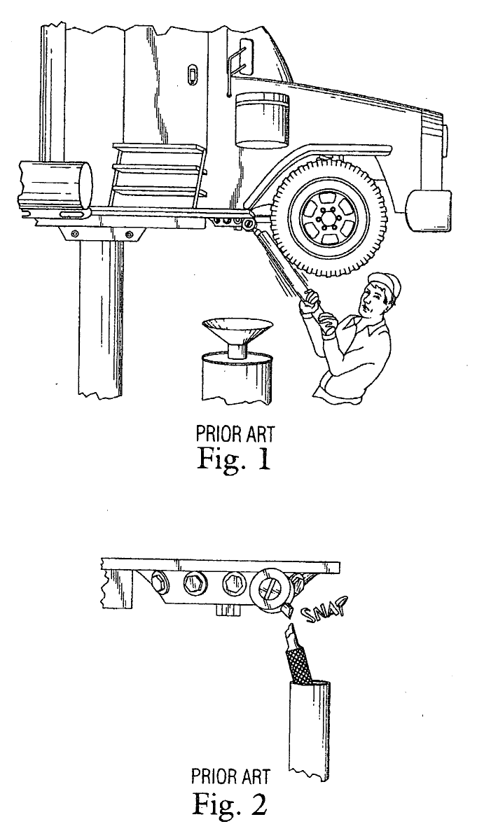

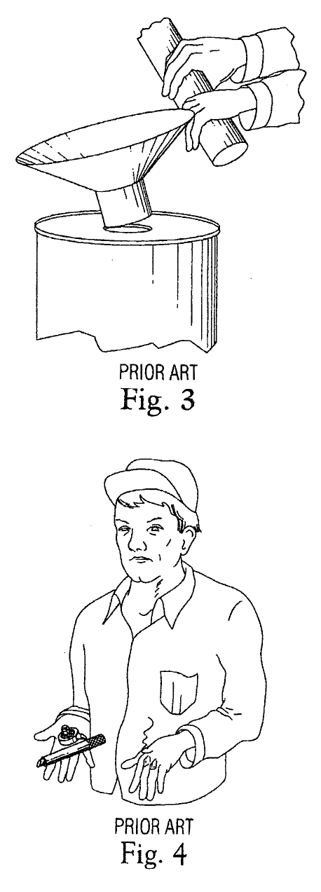

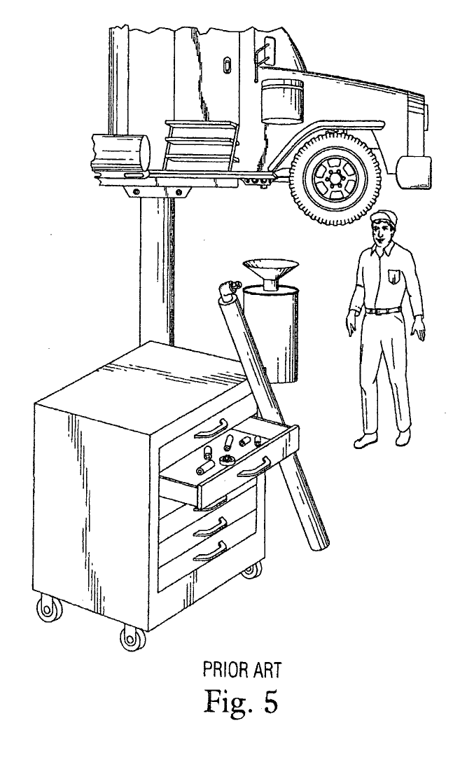

Referring to FIGS. 1-5, in the prior art, to loosen a “frozen” fastener, a wrench or ratchet wrench was fitted to the fastener and, to obtain increased leverage, a length of pipe was slid over the handle of the wrench. Leverage was applied to the distal end of the pipe. This procedure sometimes loosened the “frozen” fastener but, in many instances, the wrench was seriously damaged. In those situations where a breaker bar was used, the breaker bar was usually not in the immediate work area and the mechanic was required to go to another area to obtain the tool. The breaker bar is a heavy, awkward tool which had to be carried back to the work location.

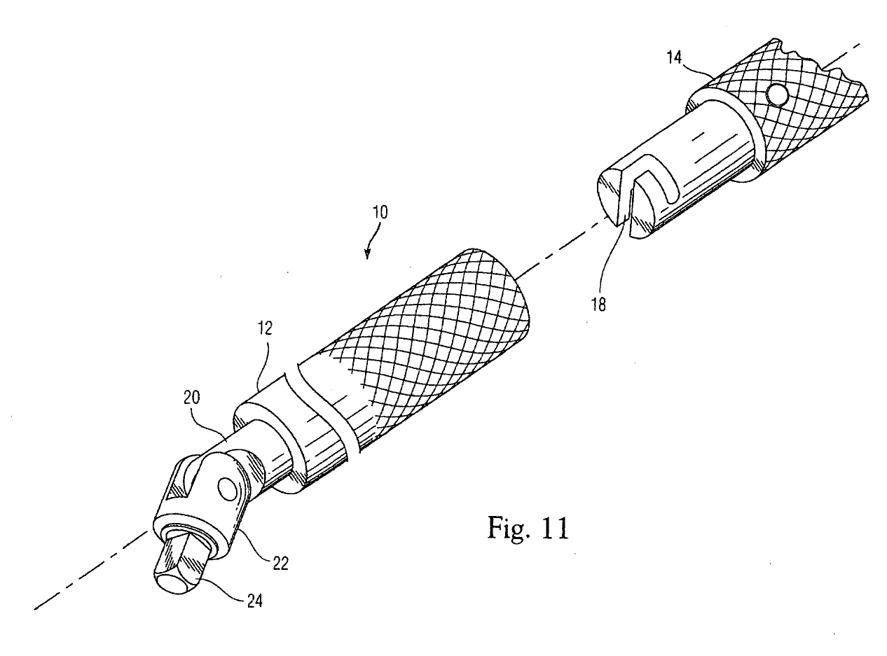

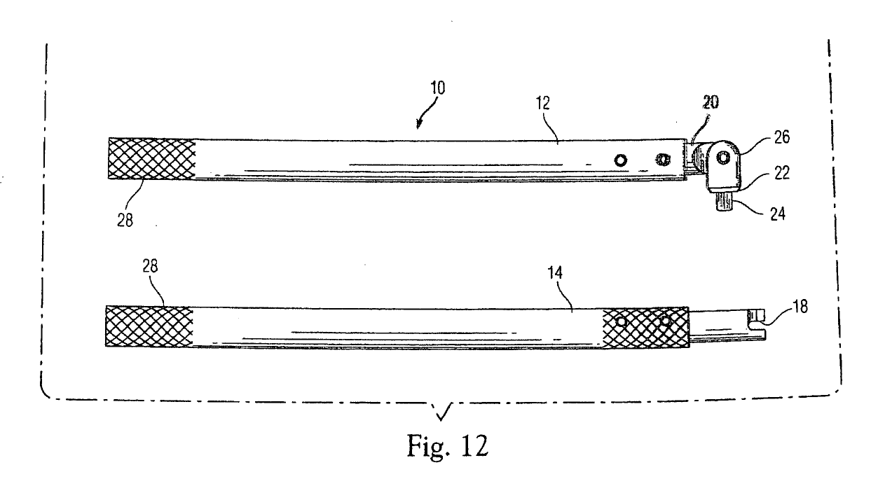

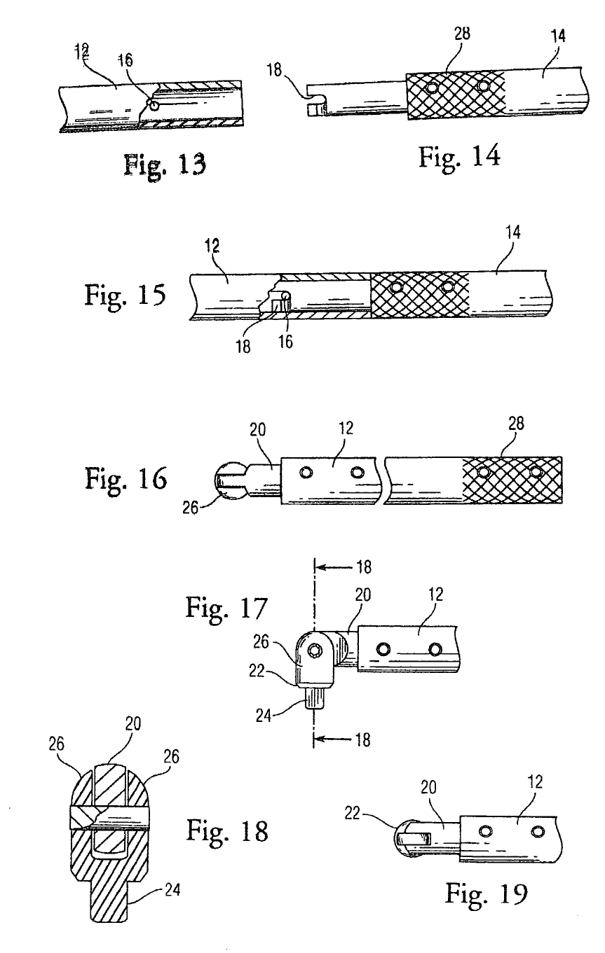

Referring to FIGS. 11 and 12, the present invention is a breaker bar having a first elongated handle 12 and a second elongated handle 14 which are connectable. Preferably, each handle is formed from a hollow tube. In a preferred embodiment the connection is by a guide connect/disconnect structure on respective opposite ends of the handles 12, 14. This quick connect/disconnect may be a bayonet lock type of connector wherein a pin 16 mounted near an end of one handle 12 (FIG. 13) engages a slot with an offset 18 near an end of the second handle 14 (FIG. 14). Twisting of the handles 12, 14 with respect to one another locks the pin 16 with the offset slot 18 (FIG. 15). Twisting the handles 12, 14 in an opposite direction disengages the pin 16 from the offset slot 18 and the handles 12, 14 are separable.

At a first end of the first handle 12, and at an opposite end from the pin 16 there is a forward projecting cleat 20. The cleat 20 is retained on the first handle 12 by a transverse pin. A member 22 is pivotally connected to the cleat 20. The member 22 has a tang 24 formed thereon wherein the tang can detachably be received in a wrench socket. In a preferred embodiment, (FIGS. 16 and 17) the cleat has a center portion and the member 22 is bifurcated, having two spaced-apart arms 26 which straddle the center portion of the cleat. Alternately, (FIG. 19) the cleat 20 may be bifurcated and the member 22 may have a single leg which is received between the bifurcated portion of cleat 20.

In a preferred embodiment each handle is formed from aluminum and is approximately two (2) feet long such that the handle fits in a conventional mechanic's tool box. When the handles are joined, the present invention has a handle length of approximately four (4) feet. Each handle has an outer diameter of approximately 1½ inches to provide the strength to apply adequate torque to the fastener without damage to the breaker bar.

The outer surface on the ends of each respective handle are knurled 28 to improve the grip which can be obtained on the handle.

In use, the operator joins the first handle to the second handle by means of the bayonet connection. The tang 24 on the first end of the handle is connected to a socket of a desired size. The socket is connected to the fastener which is “frozen”. The operator applies leverage to the end of the handle distal from the “frozen” fastener until the fastener moves and can be removed.

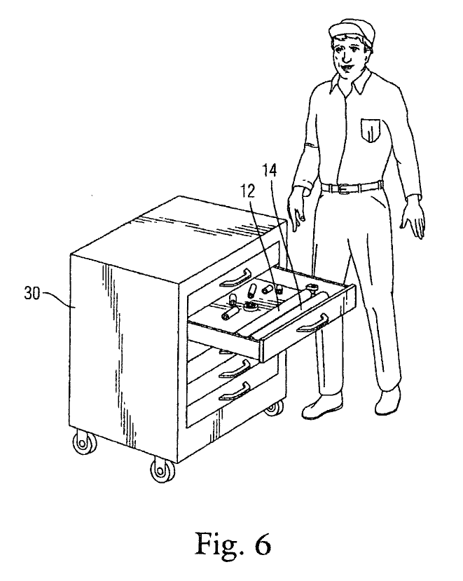

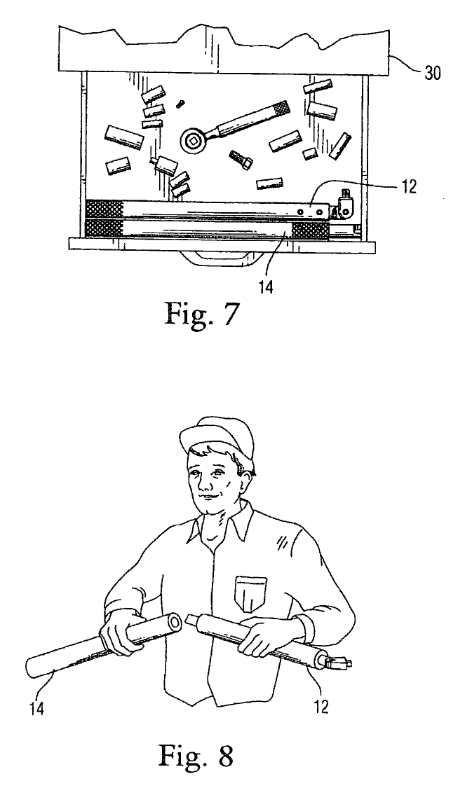

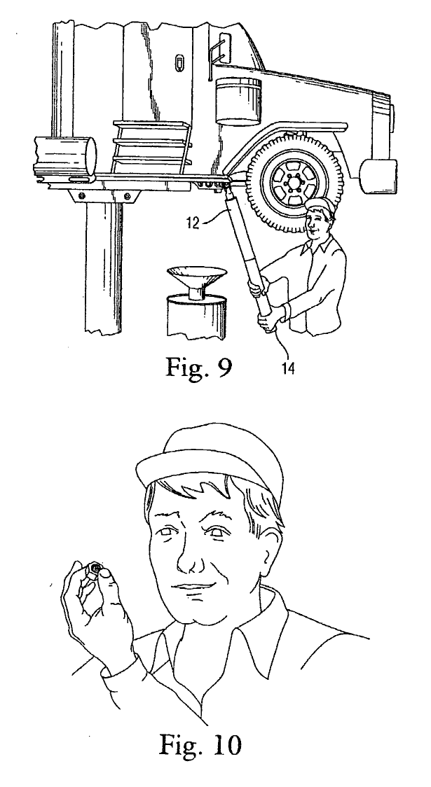

FIGS. 6-7 show the handles 12, 14 of the present invention fitted in the tray or drawer of a mechanic's tool box. FIG. 8 shows the handles 12, 14 being quickly connected by the mechanic. In FIGS. 9-10, the breaker bar of the present invention is used to loosen a “frozen” fastener without damage to a wrench. The disassembled breaker bar of the present invention is replaced in the mechanic's tool box.

Thus, the present invention provides a convenient, easily and quickly assembled breaker bar 10 which is approximately four feet long. The extension head assembly of Lee (U.S. Pat. No. 2,263,528) is threadingly connected and one handle segment has a smaller diameter to be received within the diameter of the second handle segment. Lee does not have a tang which can receive a socket of a selected size but must have a separate socket attachment connected for different size fasteners. Although Lee has been known since 1941, no one has disclosed or suggested a breaker bar like the present invention. No other patent of which the applicant is aware, has disclosed or suggested a pair of handles which conveniently fit in a mechanic's tool box and are quickly connected to each other to provide a rugged breaker bar.

What is claimed is:

1. A breaker bar comprising a first elongated handle having a forwardly-projecting cleat, a bifurcated member straddling the cleat and pivotably connected thereto by a transverse pivot pin, the member having a drive tang for removably receiving a wrench socket thereon, and a secondary elongated handle optionally connected to the first elongated handle end-to-end thereof by a quick connect/disconnect structure therebetween.

2. The breaker bar of claim 1, wherein both first and second elongated handles are of substantially the same length.

3. The breaker bar of claim 2, wherein the handles fit within a conventional mechanic's tool box or tool tray.

4. The breaker bar of claim 1, further including knurls on respective portions of the handles.

5. The breaker bar of claim 1, wherein the quick connect/disconnect structure comprises a bayonet lock.

6. A breaker bar comprising first and second elongated handles connected end-to-end thereof by a bayonet lock therebetween, thereby providing a quick connect/disconnect feature, the handles being of substantially the same length for convenient storage within a mechanic's conventional tool box or tool tray, each of the handles having respective knurled portions, the first elongated handle having a forwardly-projecting cleat, and a member pivotably connected to the cleat by transverse pivot pin, the member having a drive tang for detachably receiving a wrench socket thereon.

7. The method of removing a “frozen” nut or bolt head by use of the breaker bar of claim 6.

8. A method for using a breaker bar for removal of a fastener comprising the steps of:
providing a first elongated handle and a second elongated handle,
storing each handle in a conventional mechanic's tool box, each handle having a first end,
providing connecting means on the first ends of the handles to removably and quickly connect the handles to each other end to end, the first handle further having an opposite second end, providing a tang on said second end,
placing a wrench socket of a desired size on the tang on the first handle,
connecting the wrench socket to the fastener wherein the first and second handles extend perpendicularly from the fastener,
applying leverage to the second handle to loosen the fastener,
disconnecting the wrench socket from the loosened fastener, disconnecting the first elongated handle from the second elongated handle and placing the handles in the mechanic's tool box.

9. The method of claim 8, wherein each elongated handle has a length of approximately two feet and the connected handles have a length of approximately four feet.

10. The method of claim 8, using the breaker bar of claim 6.
